(19) United States
(12) Patent Application Publication
(10) Pub. No.: US 2026/0273858 A1
(43) Pub. Date: Sep. 17, 2026

(54) SYSTEMS AND METHODS FOR POWDER HANDLING IN ADDITIVE FABRICATION DEVICES

(71) Applicant: FORMLABS, INC., Somerville, MA (US)

(72) Inventors: Luke Boppart, Cambridge, MA (US); Chun Ho Chan, Cambridge, MA (US)

(73) Assignee: FORMLABS, INC., Somerville, MA (US)

(21) Appl. No.: 19/565,163

(22) Filed: Mar. 12, 2026

Related U.S. Application Data
(60) Provisional application No. 63/770,878, filed on Mar. 12, 2025.

(51) Int. Cl. B29C 64/357; B29C 64/153; B29C 64/182; B29C 64/194; B29C 64/268; B29C 64/329; B29C 64/393; B33Y 30/00; B33Y 40/00; B33Y 50/02

(52) U.S. Cl. CPC B29C 64/357; B29C 64/153; B29C 64/182; B29C 64/194; B29C 64/268; B29C 64/329; B29C 64/393; B33Y 30/00; B33Y 40/00; B33Y 50/02

(57) ABSTRACT

An additive fabrication system recirculates fresh and recycled powder using a hopper, an overflow chute, and an auger channel arranged so recycled powder reaches the auger channel more directly than fresh powder. A flipper and a recoater roller spread and smooth the powder. Print preparation software arranges parts using physics-based placement and natural re-flow after user adjustments, and can generate print instructions after a stable arrangement is reached.

### CROSS-REFERENCE TO RELATED APPLICATIONS

The present application claims the benefit under 35 U.S.C. § 119(e) of U.S. Provisional Patent Application No. 63/770,878, filed on Mar. 12, 2025, titled “SYSTEMS AND METHODS FOR POWDER HANDLING IN ADDITIVE FABRICATION DEVICES,” which is hereby incorporated by reference in its entirety.

### FIELD OF THE INVENTION

The present disclosure relates to additive manufacturing technologies, and specifically to powder recirculation and print preparation techniques for selective laser sintering (SLS) 3D printing technologies.

### BACKGROUND

Additive fabrication, e.g., 3-dimensional (3D) printing, provides techniques for fabricating objects (also referred to as “parts”) by causing portions of a building material to solidify at specific locations. Additive fabrication techniques may include stereolithography, selective or fused deposition modeling, direct composite manufacturing, laminated object manufacturing, selective phase area deposition, multiphase jet solidification, ballistic particle manufacturing, particle deposition, selective laser sintering or combinations thereof. Many additive fabrication techniques build parts by forming successive layers, which are typically cross-sections of the desired object. Typically each layer is formed such that it adheres to either a previously formed layer or a substrate upon which the object is built.

In one approach to additive fabrication, known as selective laser sintering, or “SLS,” solid objects are created by successively forming thin layers by selectively fusing together powdered material.

### SUMMARY

In one aspect, the present disclosure includes an additive fabrication device comprising a build chamber with an adjustable build platform, a hopper positioned below the build platform and having one or more openings that direct fresh powder into an overflow chute, an auger channel fluidly connected to the overflow chute, and a powder spreading mechanism having a flipper and a recoater roller, wherein the overflow chute, the hopper openings, and the auger channel are arranged such that recycled powder follows a more direct path to the auger channel than the fresh powder.

In another aspect, the present disclosure includes a method for recirculating powder in an additive fabrication device, involving receiving recycled powder in an overflow chute, directing fresh powder from a hopper into the overflow chute to mix with the recycled powder, directing the recycled powder along a more direct path to an auger channel than the fresh powder, transporting mixed powder upward through the auger channel, and depositing and smoothing a powder layer across the build platform with a flipper and a recoater roller.

In another aspect, the present disclosure includes a computer-implemented method for arranging parts in print preparation software for additive fabrication, comprising receiving three-dimensional model files, applying packing constraints in a virtual build volume, performing initial automatic placement with a physics-based simulation, continuing the physics-based simulation after a user adjustment to automatically reposition remaining parts without restarting the packing process, and generating print instructions after the parts reach a stable arrangement.

The foregoing apparatus and method embodiments may be implemented with any suitable combination of aspects, features, and acts described above or in further detail below. These and other aspects, embodiments, and features of the present teachings can be more fully understood from the following description in conjunction with the accompanying drawings.

### BRIEF DESCRIPTION OF DRAWINGS

Various aspects and embodiments will be described with reference to the following figures. It should be appreciated that the figures are not necessarily drawn to scale. In the drawings, each identical or nearly identical component that is illustrated in various figures is represented by a like numeral. For purposes of clarity, not every component may be labeled in every drawing.

FIG. 1A illustrates a perspective view of the exterior of a compact SLS 3D printer, according to some embodiments.

FIG. 1B illustrates a second perspective view of a compact SLS 3D printer, according to some embodiments.

FIG. 2 illustrates a cross-section view of a powder handling module of a compact SLS 3D printer with powder movement paths, according to some embodiments,

FIG. 3 illustrates a detailed view of a build chamber of a compact SLS 3D printer, according to some embodiments.

FIG. 4 illustrates a top view of a hopper of a compact SLS 3D printer, according to some embodiments.

FIG. 5 illustrates a flowchart of the method steps for powder handling and reuse in an SLS 3D printing process, according to some embodiments.

FIG. 6 illustrates a flowchart of the method of packing objects in a print preparation software for SLS 3D printing, according to some embodiments.

### DETAILED DESCRIPTION

Selective Laser Sintering (SLS) 3D printers are used for their ability to create complex parts with high precision. However, some SLS printers can face challenges in efficiently managing fresh and recycled powder, and print preparation workflows can also become inefficient when part arrangements must be repeatedly recalculated. These issues can reduce print quality, increase material waste, and slow preparation of print jobs. Accordingly, there remains a need for improved powder recirculation arrangements and more efficient print preparation workflows for additive fabrication devices.

Some powder handling systems may rely on complex mechanisms or multiple transfer steps that are cumbersome and prone to failure, and conventional print preparation tools may require substantial manual effort when a user repositions parts within a build volume. Further improvements in compact powder handling and responsive print preparation remain desirable.

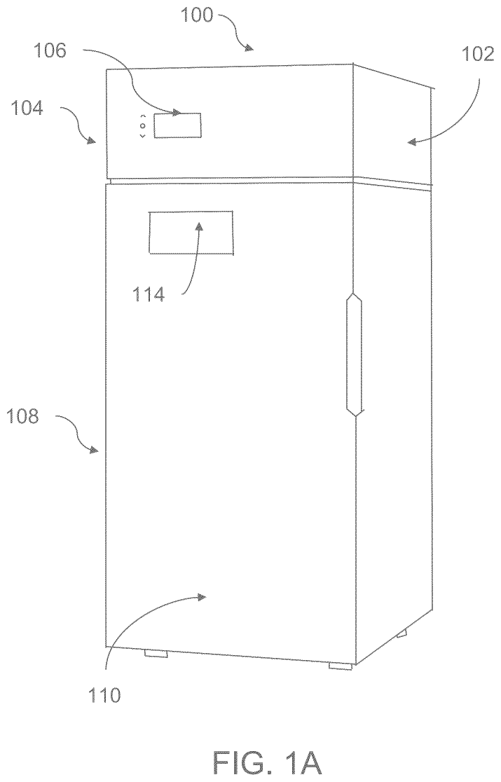

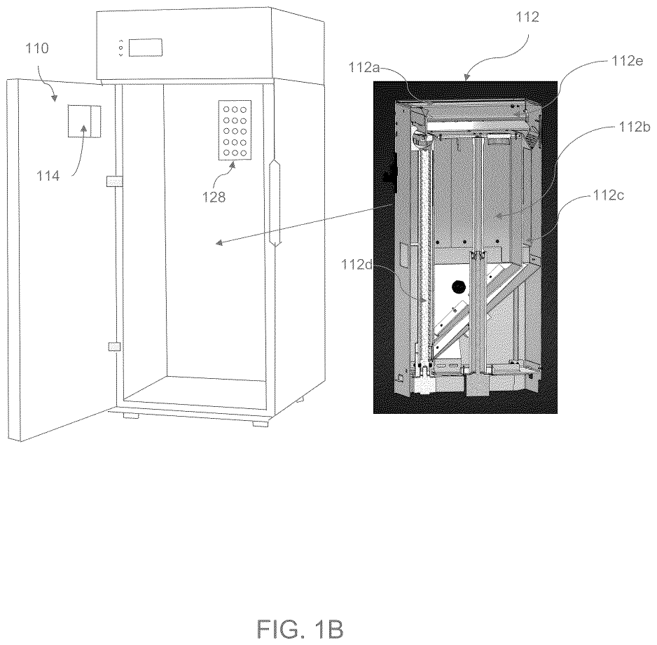

FIG. 1A provides a perspective view of the exterior of a compact SLS 3D printer 100, illustrating its structural configuration and key components as seen from the outside. The printer 100 is designed to be compact, facilitating ease of use and integration into various workspaces. The exterior of the printer 100 is encased in a robust housing 102, which serves to protect the internal components from environmental factors, create thermal insulation, and to ensure user safety. In some embodiments, the housing 102 is designed to act as a thermal barrier to maintain a suitable temperature inside the printer 100. For example, the housing 102 may include thermal insulating materials to ensure consistent internal temperatures, preventing fluctuations that could affect print quality. The thermal insulation also serves to protect users from being exposed to high-temperature working environment inside the printer 100. Alternatively or optionally, the housing 102 may include active heating elements such as PCB heaters to maintain internal working temperatures.

In some embodiments, the housing 102 is constructed from durable materials such as aluminum or high-strength plastic, providing both structural integrity and aesthetic appeal. In other embodiments, the housing 102 may be constructed from multiple layers of materials, providing structural integrity, thermal insulation, and aesthetic appeal. The printer 100 is divided vertically into a top section 104 and a bottom section 108. The top section 104, on the outside, includes a control panel 106. The control panel 106 is equipped with a user interface, potentially comprising a touchscreen display, buttons, dials, or other control devices allowing the operator to input commands, monitor the printing process, and adjust settings as necessary. In some embodiments, the control panel 106 may also include connectivity options such as USB ports or wireless communication modules for data transfer and remote operation.

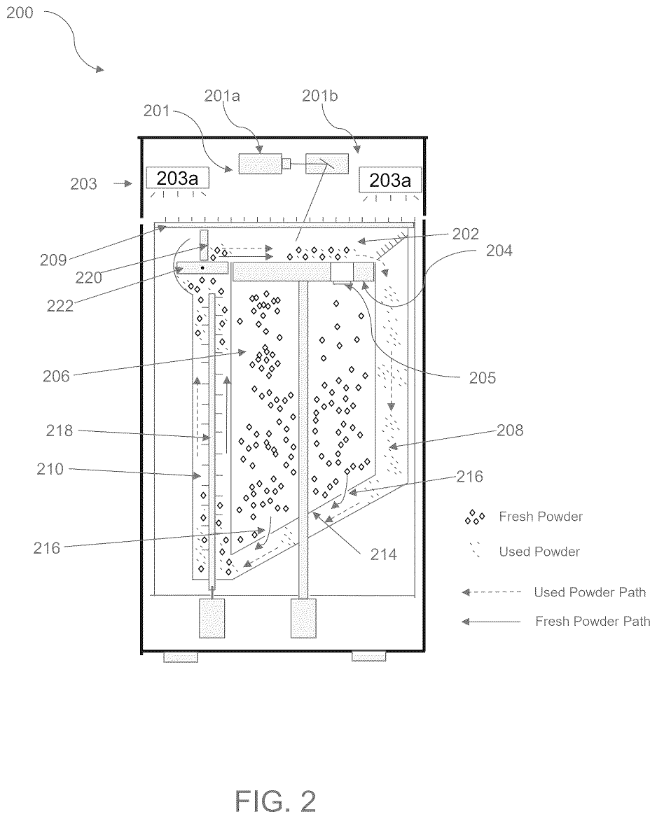

In some embodiments, the top section 104 houses a heating module and a laser module (will be discussed in more detail in FIG. 2). The heating module is responsible for maintaining the optimal temperature within the build chamber, ensuring that the powder remains at a consistent temperature for effective sintering. In some embodiments, the heating module uses both active heating methods, such as operating quartz heaters, and passive methods, such as installing heat reflectors above the quartz heaters or placing a glass panel over the build chamber to spread heat and maintain chamber temperature. These heating methods and elements will be described in detail later in the disclosure.

The laser module, on the other hand, is used to selectively fuse the powder particles together to form the desired 3D printed object. The laser precisely targets the powder layer by layer, following the digital design to create complex and high-precision parts. Typically, a galvanometer (galvo) system is employed to direct the laser beam with high accuracy and speed. For example, the galvo system includes a mirror system that pivots on galvanometer motors, allowing the laser beam to be rapidly and precisely steered across the powder bed. This ensures that the laser can follow intricate paths and create detailed features in the printed object.

The laser used in SLS 3D printers generally operates in the infrared spectrum, such as by CO2 or fiber lasers. The combination of the laser's wavelength, power, and the precision of the galvo system enables the creation of high-quality, durable parts with fine details and complex geometries.

In some embodiments, the bottom section 108 of the printer 100 houses the powder handling module 112. The powder handling module 112 includes several key components essential for efficient operation, such as the hopper, overflow chute, and auger channel. The hopper stores and dispenses powder, while the overflow chute and auger channel work together to manage excess powder and ensure its efficient recirculation within the system. Each of these components will be described in detail later in this disclosure.

A door 110 on the lower section 108 of the compact SLS 3D printer 100 is designed to provide easy access to the powder handling module 112. In some embodiments, the door 110 is hinged and can be opened to reveal the internal components. The door 110 may be equipped with a locking mechanism (e.g., mechanical locking and/or magnetic locking) to ensure it remains securely closed during printing operations, thereby preventing any accidental exposure to the powder handling components. In some embodiments, the door 110 may include a viewport 114 made from transparent or semi-transparent materials, such as tempered glass or polycarbonate, allowing the user to visually inspect the powder handling module 112 without opening the door.

In some embodiments, the door 110 of the compact SLS 3D printer is equipped with a high-quality seal to ensure an airtight and secure closure. This seal is essential for maintaining a controlled environment within the printer, preventing any external contaminants from entering the powder handling module. The seal may be constructed from durable materials such as silicone, rubber, or polyurethane, which provide excellent flexibility and resilience. Additionally, the seal is designed to withstand the high temperatures and pressures associated with the SLS printing process, ensuring long-term reliability and performance.

In alternative embodiments, the housing 102 of the printer 100 may feature additional access panels or removable sections to facilitate maintenance and cleaning of the internal components. These panels could be secured with screws, latches, or magnetic closures, providing both security and ease of access. Furthermore, the housing 102 may be designed with ventilation openings or cooling fans to dissipate heat generated during the printing process, thereby maintaining optimal operating temperatures and prolonging the lifespan of the printer's components.

The compact design of the SLS 3D printer 100, as illustrated in FIG. 1A, is intended to maximize efficiency and functionality while minimizing the device's footprint. This design consideration is particularly advantageous for users with limited workspace, as it allows the printer 100 to be easily accommodated in a variety of settings, from small workshops to larger industrial environments. The integration of the powder handling module 112 within the bottom section 108 further contributes to the printer's compactness, ensuring that all necessary components are contained within a single, cohesive unit. FIG. 1B illustrates another perspective view of the exterior of the compact SLS 3D printer 100 with the door 110 in an open position, according to some embodiments. FIG. 1B provides a detailed view of space inside the bottom section 108 that houses the powder handling module 112. The powder handling module 112 includes at least the cover glass 112a, build chamber 112e, hopper 112b, overflow chute 112c, and auger channel 112d.

In some embodiments, the module 112 includes a removable cover glass 112a, a hopper 112b, an overflow chute 112c, an auger channel 112d, and a build chamber 112e. The hopper 112b stores and dispenses powder, while the overflow chute 112c and auger channel 112d work together to manage excess powder and ensure its efficient recirculation within the system. In some embodiments, the hopper 112b features a slanted bottom surface, which facilitates the gravitational flow of powder towards side openings located at the bottom of the hopper, thus directing the powder into the path of the overflow chute 112c. The auger channel 112d, equipped with one or more screw augers powered by one or more motors, transports the powder (e.g., a mix of recycled powder entered from the overflow chute, and fresh powder from the hopper) from the bottom of the channel to the top, where it is fed back into the build chamber 112e. Each of these components inside the powder handling module 112 will be described in detail later in this disclosure.

The powder handling module 112 in the compact SLS 3D printer 100 is engineered for mobility, facilitating its insertion and removal from the designated space in the bottom section 108 of the printer. This feature facilitates the refilling of powder and the removal of parts, enhancing the overall user experience. Unlike traditional SLS printers, which typically do not allow the entire powder handling system to be detached from the printer, this design significantly simplifies maintenance and operational tasks. Traditional systems often require complex disassembly to access the powder handling components, making the process cumbersome and time-consuming. In contrast, the compact SLS 3D printer's modular design ensures that the powder handling module 112 can be quickly and easily accessed, refilled, cleaned, or maintained, thereby improving efficiency and reducing downtime.

In some embodiments, the module 112 is designed to be lightweight, enabling a user to manually remove it from or insert it into the bottom section 108 with ease. For example, ergonomically designed handles are integrated into the module to facilitate a secure grip, allowing the user to lift and maneuver the module comfortably. Additionally, the module's dimensions are optimized to ensure that it can be easily aligned and positioned within the bottom section 108, minimizing the effort required for insertion and removal.

In some embodiments, the module 112 is mounted on integrated rails secured inside the bottom section 108, which provide a guided path for smooth sliding motion. To remove the module 112, the user first disengages a set of locking switches. These locking switches secure the module 112 in place during operation, preventing any unintended movement. Once the locking switches are adjusted to the unlocked position, the user can slide the module 112 out along the rails. Ball bearings within the rail system facilitate a frictionless movement, reducing the effort required to remove the module.

In some embodiments, the bottom of the module 112 is equipped with wheels. These wheels allow the module 112 to be rolled in and out of the bottom section 108. To remove the module 112, the user first disengages the locking switches and then pulls the module out by its handles. To reinsert the module 112, the user simply rolls it back into place, where it aligns with guide slots or pins. The locking switches are then re-engaged to secure the module.

In some embodiments, telescoping arms that extend and retract are used to move the module 112. These arms are mounted on the sides of the bottom section 108 and can be extended to pull the module out. The user first disengages the locking switches and then activates a release lever to extend the telescoping arms. The arms pull the module out smoothly, and once fully extended, the module can be lifted off the arms for complete removal. To reinsert, the user places the module back on the arms and retracts them, guiding the module back into its secured position. The locking switches are then engaged to lock the module in place.

In some embodiments, sliding tracks combined with magnetic latches are used to move the module 112. The module 112 can be placed on sliding tracks that guide it in and out of the bottom section 108. Magnetic latches provide an initial hold, making it easier for the user to engage the locking switches and side tabs. To remove the module, the user disengages the locking switches and pulls the module out along the sliding tracks. The magnetic latches release automatically as the module is pulled out. To reinsert, the user slides the module back along the tracks, where the magnetic latches help align it into place. The locking switches are then re-engaged to secure the module.

In some embodiments, a lift-and-lock mechanism can also be employed, where the module 112 is lifted slightly to disengage it from locking pins or tabs before it can be pulled out. The user first disengages the locking switches and then lifts the module using built-in handles. This lifting action disengages the locking pins or tabs, allowing the module to be pulled out smoothly. To reinsert, the user aligns the module with the locking pins or tabs and lowers it into place. The locking switches are then engaged to secure the module.

For added convenience, the module 112 may also feature a set of guide pins that align with corresponding slots in the bottom section 108. These guide pins ensure precise positioning and prevent any misalignment during the insertion process. Additionally, the module may include a set of magnetic latches that provide an initial hold, making it easier for the user to engage the locking switches and side tabs.

Overall, the design of the powder handling module 112 prioritizes ease of use, safety, and reliability, ensuring that users can effortlessly manage the module's insertion and removal as needed.

To further enhance safety and usability, the printer 100 may include temperature sensors that monitor the internal environment. These sensors can provide real-time feedback, alerting the user if the temperature is too high to safely remove the powder handling module 112. Once the temperature is within a safe range, the user can proceed to open the door 110 and remove the module 112 for refilling or maintenance. This feature ensures that the powder handling module 112 can be accessed without risking damage to the components or injury to the user.

In some embodiments, the compact SLS 3D printer 100 also includes an air filter module 128 located at the back of the bottom housing. This module 128 is designed to ensure that any powder particles that may escape during the printing process are effectively captured and filtered, preventing them from dispersing into the surrounding environment.

The fan (not shown) draws air from inside the printer housing, directing it through a series of filters before releasing it back into the workspace.

Several types of filters can be employed in this module 128 to achieve optimal air quality. One option is a High-Efficiency Particulate Air (HEPA) filter, which is capable of capturing particles as small as 0.3 microns with an efficiency of 99.97%. This type of filter is highly effective in trapping fine powder particles, ensuring that the air released from the printer 100 is clean and safe to breathe.

Another option is an activated carbon filter, which can be used in conjunction with the HEPA filter. The activated carbon filter is particularly effective at removing odors and volatile organic compounds (VOCs) that may be generated during the printing process. By combining these two types of filters, the fan and filter module 128 can provide comprehensive air purification, addressing both particulate matter and gaseous contaminants.

In some embodiments, the filter module 128 may also include an electrostatic precipitator, which uses an electric charge to attract and capture powder particles. This technology can be particularly effective in environments where fine powder particles are prevalent, as it can capture particles that may pass through traditional filters.

The fan and filter module 128 is designed to be easily accessible for maintenance, allowing users to replace filters as needed to ensure continued effective operation. This feature enhances the overall usability and safety of the compact SLS 3D printer 100, providing a cleaner and healthier workspace for users.

FIG. 2 illustrates a cross-section view of the compact SLS 3D printer, according to some embodiments. FIG. 2 focuses on the powder handling module 200 with various powder flow paths. The module 200 is integral to the printer's operation, ensuring optimal powder flow and reuse, which are critical for maintaining high print quality and minimizing material waste. The module 200 comprises several key components, including a build chamber 202, an adjustable build platform 204, a hopper 206, an overflow chute 208, and an auger channel 210, each strategically designed and positioned to enhance the overall functionality of the system.

The build chamber 202 is a central feature of the powder handling module 200, defined at the bottom by the adjustable build platform 204. The build platform 204 is designed to move vertically within the module 200 to change the size of the chamber 202, allowing for precise layer-by-layer construction of 3D printed parts. During the printing process, the build platform 204 moves down by a layer height after each layer is completed. Powder is then recoated across the build platform 204, followed by the lasing process where the laser, positioned above the build chamber 202, selectively fuses the powder to form the desired part geometry. After lasing, the layer is allowed to cool before the next layer is applied, ensuring the structural integrity and precision of the printed part.

In some embodiments, the build platform 204 serves to separate the build chamber 202 from the hopper 206 (which is used to store fresh powder) underneath. In some embodiments, the build platform 204 includes a valve 205 that can be opened, allowing the user access to the hopper 206, e.g., to fill it with fresh powder.

In some embodiments, the valve 205 is securely attached to the build platform 204 through a threaded connection. The valve 205 features external threads that correspond to internal threads within the opening of the build platform 204. This threaded engagement ensures a tight and secure fit, preventing any leakage of powder when the valve 205 is closed. Additionally, a gasket or O-ring may be incorporated between the valve 205 and the build platform 204 to enhance the seal and prevent any powder from escaping.

To ensure that the valve 205 sits flush with the surface of the build platform 204, the valve 205 is designed with a flat upper surface that aligns with the top surface of the build platform 204 when fully closed. This design minimizes any protrusions that could interfere with the build process or the movement of the build chamber components. The flush design also contributes to the overall aesthetic and functional integrity of the system, providing a smooth and continuous surface.

For ease of operation, the valve 205 may include a recess or indentation on its upper surface. This recess is ergonomically designed to accommodate a user's fingers or a tool, allowing for easy rotation of the valve 205 to open or close it. The recess can be textured or knurled to provide additional grip, ensuring that the user can effortlessly rotate the valve 205 even when wearing gloves or when the surface is covered with powder. This feature enhances the user experience by making the valve 205 operation intuitive and efficient.

In some embodiments, the valve 205 may also include a locking mechanism to prevent accidental opening during the build process. This mechanism could involve a simple twist-lock or a more complex latch system that secures the valve 205 in place. The locking mechanism ensures that the valve 205 remains securely closed, maintaining the integrity of the build chamber 202 and preventing any unintended release of powder.

In some embodiments, the vertical movement of the build platform 204 is facilitated by various mechanisms capable of fine adjustments to accommodate the varying heights of different print jobs. These mechanisms may include screw-driven systems such as lead screws or ball screws, which convert rotational motion into precise linear motion. Stepper motors with microstepping capabilities can also be employed for enhanced precision. Alternatively, hydraulic or pneumatic systems may be used, where a cylinder and piston mechanism provides the necessary force and control. Electric linear actuators, including piezoelectric actuators, offer another means of achieving fine vertical movement. Additionally, cam mechanisms, rack and pinion systems, voice coil actuators, and magnetic levitation systems can be considered, each offering different advantages in terms of precision, load capacity, and operational smoothness.”

The goal of the vertical movement of the build platform 204 is to facilitate the layer-by-layer construction of a three-dimensional object through the Selective Laser Sintering (SLS) process. In this process, the build platform 204 is incrementally lowered after each layer of powder is selectively fused by a laser. Initially, a thin layer of powder is spread across the build platform 204 by a recoating mechanism. The laser then scans the cross-sectional area of the object on the powder layer, sintering the powder particles together to form a solid layer. Once a layer is completed, the build platform 204 is lowered by a precise amount, typically corresponding to the thickness of a single layer. This synchronized lowering allows the recoating mechanism to spread a new layer of powder over the previously sintered layer. The process is repeated, with the laser fusing each new layer of powder to the layer beneath it, until the entire object is formed. The precise control of the build platform's vertical movement is crucial for maintaining the accuracy and quality of the final object, ensuring that each layer is uniformly thick and properly aligned with the preceding layers.

Positioned below the build platform 204 is the hopper 206, which serves as the primary storage and dispensing unit for the powder used in the printing process. The hopper 206 features a slanted bottom surface 214, designed to promote the gravitational flow of powder. These side openings 216 are crucial for directing the powder into the overflow chute 208, ensuring that any fresh powder from the hopper 206 and excess powder from the overflow chute 208 is efficiently mixed and recirculated within the system. The hopper 206 may be constructed from materials such as aluminum or stainless steel, with potential coatings like Teflon applied to reduce powder adhesion and facilitate smooth flow.

The mechanism responsible for the vertical movement of the build platform 204, whether it be a lead screw, hydraulic tube, or another system, is designed to run through the hopper 206. This integration ensures that the build platform 204 can be precisely adjusted in height while maintaining the structural integrity and functionality of the hopper 206. For example, the lead screw or hydraulic tube is centrally positioned within the hopper 206, allowing for unobstructed movement and efficient use of space. This design ensures that the powder flow within the hopper 206 is not impeded, and the vertical movement mechanism remains protected from powder contamination.

In some embodiments, the lead screw or hydraulic tube may be enclosed within a protective sleeve or casing as it passes through the hopper 206. This casing serves to shield the mechanism from powder contamination and mechanical wear, ensuring long-term reliability and precision. The casing may be constructed from materials that are resistant to abrasion and corrosion, providing an additional layer of protection for the vertical movement mechanism. This design consideration helps to maintain the overall performance and accuracy of the build platform 204, contributing to the quality and consistency of the printed objects.

The top of the hopper 206 is defined by the bottom surface of the build platform 204, which serves as a sealing surface to prevent powder from escaping into the build chamber 202. The build platform 204 is designed to fit snugly against the top edges of the hopper 206, creating a secure and stable interface. The bottom of the hopper 206 is characterized by the slanted bottom surface 214, which promotes the gravitational flow of powder towards the side openings 216. This slanted design ensures that powder is efficiently directed towards the overflow chute 208.

The hopper 206 is enclosed within the housing of the powder handling module 200. This housing provides structural support and protection for the hopper 206, ensuring that the powder remains contained and the flow is controlled. The housing is typically constructed from durable materials such as aluminum or stainless steel, which can withstand the operational stresses and environmental conditions of the SLS process.

In some embodiments, to further enhance the efficiency of powder handling, the interior surfaces of the hopper 206 may be coated with specialized materials designed to facilitate smooth powder movement. Coatings such as Teflon or other non-stick materials can be applied to reduce powder adhesion and minimize the risk of clogging or buildup within the hopper 206. These coatings create a low-friction surface, allowing the powder to flow more freely towards the slanted bottom surface 214 and through the side openings 216. By reducing the resistance encountered by the powder, these coatings help to ensure a consistent and reliable supply of material to the build platform 204, ultimately contributing to the overall quality and precision of the SLS printing process. Additionally, such coatings can extend the lifespan of the hopper 206 by protecting it from abrasive wear and corrosion, further enhancing the durability and performance of the powder handling system.

In some embodiments, the hopper 206 may include a free-floating plate (not shown in FIG. 2) designed to enhance the efficiency of powder handling by breaking up any clumps or agglomerations of powder. This plate is not fixed to any part of the hopper 206 but is instead connected to a motor. The motor induces vibrations in the plate, causing it to move freely within the hopper 206. The ‘free floating’ nature of the metal plate allows it to interact dynamically with the powder, effectively breaking up clumps and ensuring a consistent flow of material. This design is particularly advantageous because it does not require any fixed mounting points, which could otherwise impede the flow of powder or create areas where powder could accumulate and cause blockages. The free-floating plate is more efficient in powder breaking than a plate attached to the hopper because it can move independently, allowing it to adapt to the powder's movement and break up clumps more effectively. This dynamic interaction ensures a more consistent flow of material, reducing the risk of blockages that can occur with fixed mounting points. Additionally, the absence of fixed mounting points minimizes areas where powder could accumulate, further enhancing the efficiency of powder handling.

The motor responsible for vibrating the metal plate can be controlled to adjust the frequency and amplitude of the vibrations, allowing for precise tuning based on the specific characteristics of the powder being used. This flexibility ensures that the system can handle a wide range of powder types and conditions, maintaining optimal performance across different printing scenarios.

As an alternative embodiment, other types of vibration devices can be integrated into the hopper 206 to break up powder clumps and enhance flow. For instance, a series of small, strategically placed vibratory motors could be mounted on the walls of the hopper 206. These motors would induce vibrations through the hopper walls, effectively agitating the powder and preventing clumping. This approach allows for a more uniform distribution of vibrations throughout the hopper 206, ensuring that all areas of the powder bed are effectively managed. Another alternative embodiment could involve the use of ultrasonic transducers mounted on the hopper 206. These transducers generate high-frequency sound waves that propagate through the powder, breaking up clumps and promoting a smooth flow. Ultrasonic vibration is particularly effective for fine powders that are prone to agglomeration, as the high-frequency waves can penetrate deeply into the powder bed and dislodge even the smallest clumps.

In some embodiments, a combination of these vibration methods could be employed to achieve optimal powder handling performance. For example, the ‘free floating’ metal plate could be used in conjunction with external vibratory motors or ultrasonic transducers to provide a multi-faceted approach to powder management. This combination would ensure that the powder remains free-flowing and evenly distributed, ultimately contributing to the quality and precision of the SLS printing process.

By incorporating these various vibration devices, the hopper 206 can maintain a consistent and reliable supply of powder to the build platform 204, reducing the risk of clogs and ensuring smooth operation. These enhancements not only improve the efficiency of the powder handling system but also extend the lifespan of the hopper 206 and its components by minimizing wear and tear. Ultimately, these design considerations contribute to the overall performance and reliability of the SLS 3D printer, ensuring high-quality print results and long-term operational success.

The overflow chute 208, the auger channel 210, and the hopper 206 work together to manage, recirculate, and mix powder within the system. The overflow chute 208 receives recycled powder from the build chamber and mixes the recycled powder with fresh powder introduced from the hopper 206. In some embodiments, the overflow chute 208, the hopper 206, and the auger channel 210 are arranged so that the recycled powder follows a more direct path to the auger channel 210 than the fresh powder, thereby promoting reuse of the recycled powder while still maintaining a sufficient supply of fresh powder. The auger channel 210 then transports the powder back to the build chamber 202 to maintain a continuous supply of material for the printing process.

In some embodiments, the overflow chute 208 is strategically positioned opposite the auger channel 210 relative to the hopper 206. This configuration is designed to optimize the flow of excess powder, which is guided by gravity down the chute 208 and into the auger channel 210. The overflow chute 208 may be constructed from durable materials such as aluminum or stainless steel, and in some embodiments, it may be coated with non-stick materials to prevent powder adhesion and ensure smooth movement. In alternative embodiments, the overflow chute 208 may incorporate vibrations or additional lubricant coatings to further enhance powder movement and prevent sticking.

In some embodiments, the auger channel 210 is a vertical conduit adjacent to the hopper 206 and includes at least one screw auger 218 driven by a motor located at a bottom end of the auger channel 210. The at least one screw auger 218 transports powder from the bottom of the auger channel 210 to the top, where the powder is returned to the build chamber 202 for deposition by a flipper 222 and a recoater roller. In various embodiments, the auger channel 210 may use a single-screw configuration or a multi-screw configuration depending on desired flow characteristics and clogging reduction, and a vibratory feeder may be used in combination with or as an alternative to the screw auger arrangement.

The path and mechanism of powder circulation will be described in more detail later in this disclosure.

In some embodiments, the powder handling module 200 may incorporate additional features such as sensors to monitor powder levels and flow rates, providing real-time feedback and enabling automatic adjustments to the system. These sensors could be integrated into the hopper 206, overflow chute 208, or auger channel 210, offering enhanced control and optimization of the powder handling process. The integration of such sensors would allow for more precise management of the powder flow, ensuring that the system operates at peak efficiency.

The components of the powder handling module 200 are primarily constructed from aluminum sheets, although other materials such as stainless steel may be used for increased durability and resistance to wear. Active heaters, such as PCB heaters, and/or thermal insulation materials may be installed on the wall of the powder handling module 200 to help maintain a temperature inside the powder handling module 200.

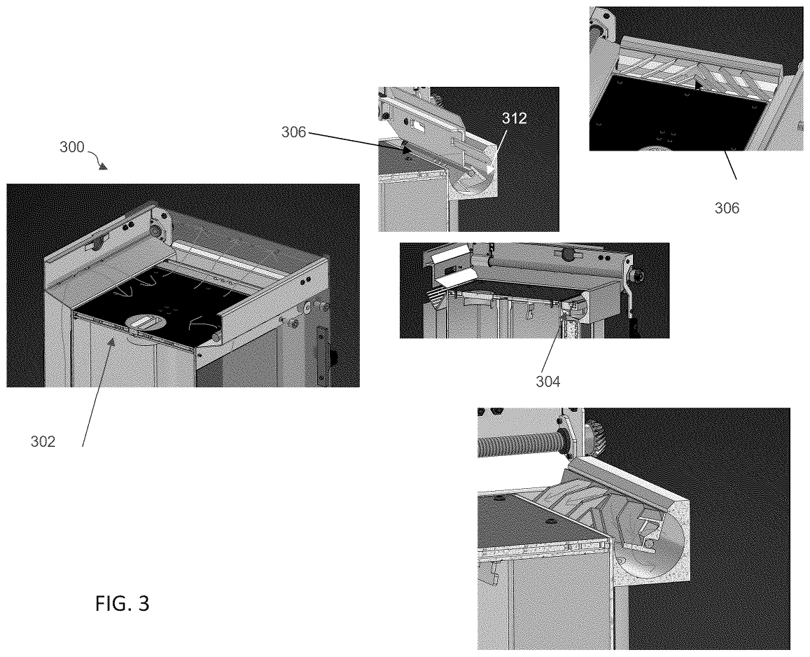

FIG. 3 provides a detailed illustration of the build chamber 300 (corresponding to the build chamber 202 in FIG. 2), focusing on the components that facilitate the powder spreading mechanism. The build chamber 300 includes the build platform 302 (corresponding to the build platform 204 in FIG. 2) and the powder spreading mechanism, which includes a flipper 304 (corresponding to the flipper 222 in FIG. 2) and a recoater roller 306. These elements work in concert to ensure the even distribution of powder across the build platform 302, which is essential for achieving high-quality prints with precise layer formation.

The build platform 302 is adjustable in height within the SLS machine, allowing for precise control over the layer-by-layer construction of 3D printed parts. This adjustability is typically achieved through a screw-driven or piston mechanism, although alternative methods such as a hydraulic system may also be employed. The build platform 302 is constructed from durable materials such as aluminum or stainless steel, providing the necessary strength and stability to support the weight of the printed parts and the powder layers. The build platform 302 is positioned on top of the hopper. As the build platform 302 lowers, the powder stored in the hopper is recirculated (see powder flow path shown in FIG. 2) and spread across the top of the build platform 302. This ensures a continuous supply of powder for the layer-by-layer construction of 3D printed parts.

While one side of the flipper 304 features the “chevron pattern” 306a (or any of the above-mentioned patterns), the other side of the flipper 304 is a flat side. The chevron pattern consists of channels that are slantedly installed on one side of the flipper 304. The entrances of these channels are concentrated near the middle of one end of the flipper 304's edge (entrance end), while the exits are spread evenly across the opposite edge and allow the distribution of powder evenly across build platform 302 (exit end). When the flipper 304 rotates, powder is scooped into the channels of the chevron pattern 306a from the narrower entrance end and channeled to the wider exit end. This design ensures that powder is evenly spread across the build platform 302, enhancing the quality of the printed layers. This pattern helps to break up any clumps of powder, ensuring a more uniform spread. The recoater roller 306 follows the flipper 304, smoothing the powder layer to achieve a consistent thickness over the entire build platform 302. The recoater roller 306 may be constructed from materials such as rubber or silicone, which provide the necessary flexibility and durability to withstand repeated use.

Alternatively or optionally, other patterns may be implemented on the flipper 304 to achieve the same effect of breaking up powder clumps and aiding the distribution of powder on the build platform 302. In some embodiments, the flipper 304 may include a wavy pattern. This pattern consists of continuous, undulating channels that allow powder to pass through while breaking up clumps, promoting a uniform distribution of powder across the build platform 302.

In some embodiments, the flipper 304 may include multiple straight channels running directly from one side of the flipper to the other, allowing powder to pass through easily while breaking up clumps and ensuring a uniform distribution of powder across the build platform 302.

In some embodiments, the flipper 304 may be designed with a zigzag pattern. This pattern features sharp, angular channels that direct the powder through the flipper, breaking up clumps and ensuring an even distribution of powder across the build platform 302.

In some embodiments, the flipper 304 may incorporate a diamond pattern with channels. This pattern includes diamond shapes arranged to create continuous channels that run from one side to the other, allowing powder to flow through while breaking up clumps.

In some embodiments, the flipper 304 may feature a honeycomb pattern with channels. This pattern consists of hexagonal cells with connecting channels that allow powder to pass through, effectively breaking up clumps and ensuring an even spread across the build platform 302.

In some embodiments, the flipper 304 may be designed with an arrow pattern. This pattern consists of continuous arrow-shaped channels pointing in the direction of powder flow, guiding the powder through while breaking up clumps and ensuring an even distribution.

In some embodiments, the flipper 304 may incorporate a fishbone pattern. This pattern features a central spine with angled channels extending outward, directing the powder through the flipper and breaking up clumps to ensure an even spread across the build platform 302.

The flipper 304 is uniquely shaped and positioned inside a cylindrical cavity 312. It is configured to rotate around its longitudinal axis within this cavity 312. An auger channel 314 is located directly below the cavity 312, pushing powder into the cavity 312 for the flipper 304 to prepare the powder for the recoater roller 306 to spread across the build platform 302. This configuration ensures efficient and consistent powder distribution, which is crucial for high-quality print layers.

In some embodiments, the flipper 304 and the recoater 306 work in a synchronized manner to ensure efficient and even distribution of powder across the build platform 302. Initially, the flipper 304 performs a few rotations to scoop powder from the auger channel 314/cavity 312 into its chevron-patterned channels. These channels help break up any clumps and guide the powder towards the build platform 302. Once the flipper 304 has collected enough powder, it rotates again to deposit the powder evenly across the build platform 302.

After the flipper 304 has completed its task, it performs another rotation to position its flat side over the build platform 302. This parked position ensures that the chevron-patterned side is not in contact with the powder, allowing the recoater 306 to move smoothly. The recoater 306 then starts its operation, moving across the build platform 302 to spread the powder layer evenly. The recoater 306's roller smooths out the powder, ensuring a consistent thickness and preparing the surface for the next layer of the 3D printing process.

This synchronized operation between the flipper 304 and the recoater 306 ensures that each layer of powder is evenly distributed and properly prepared, which is crucial for achieving high-quality prints with precise layer formation. The coordination between these two components minimizes powder waste and enhances the overall efficiency of the SLS 3D printing process.

In some embodiments, the flipper 304 and recoater roller 306 may be adjustable in terms of their speed and pressure, allowing for fine-tuning of the powder spreading process. This adjustability can be particularly beneficial when working with different types of powder materials, as it enables the operator to optimize the spreading parameters for each specific material. Additionally, the flipper 304 and recoater roller 306 may be equipped with sensors to monitor their performance, providing real-time feedback and enabling automatic adjustments to ensure optimal operation.

The components of the build chamber 300, including the build platform 302, flipper 304, and recoater roller 306, are primarily constructed from aluminum sheets, although other materials such as stainless steel or high-strength plastics may be used for increased durability and resistance to wear. In some embodiments, the build chamber 300 may be designed with a modular approach, allowing for easy detachment and cleaning of the components. This modularity improves maintenance and longevity, ensuring that the SLS 3D printer remains efficient and reliable over extended periods of use.

A plume shield 308 is positioned on the side of the build platform 302. The recoater roller 306 pushes excess powder into an overflow chute 310, which is adjacent to the plume shield 308. The plume shield 308 prevents powder from spreading uncontrollably and contaminating the rest of the build chamber 300. This feature ensures a cleaner and more controlled environment within the build chamber, enhancing the overall quality and reliability of the printing process. The plume shield 308 can be made from either hard material or flexible material. When it is flexible, it allows the recoater to push excess powder into the overflow chute 310 and then returns to its original position to prevent plume from escaping. Alternatively, the plume shield 308 could be designed with adjustable flaps or louvers that can be manually or automatically controlled to direct the flow of excess powder more precisely. These adjustable elements would allow for fine-tuning of the powder containment, ensuring that the powder is efficiently directed into the overflow chute 310 while minimizing any potential for airborne particles to escape into the build chamber.

Additionally, a mesh or filter is positioned below the plume shield 308 to break apart clumps of powder as they fall through the overflow chute. This ensures that the powder is in a fine, consistent state, enhancing the efficiency of the powder handling system and reducing the risk of clogging. For example, the mesh could be a stainless steel wire mesh with predefined grid size, which is fine enough to break up clumps without restricting powder flow. Alternatively, the filter could be a perforated metal sheet with holes of varying diameters to progressively break down larger clumps as the powder falls through. Another option could be a multi-layered mesh system, where each layer has a different grid size to ensure thorough breaking of clumps and consistent powder flow.

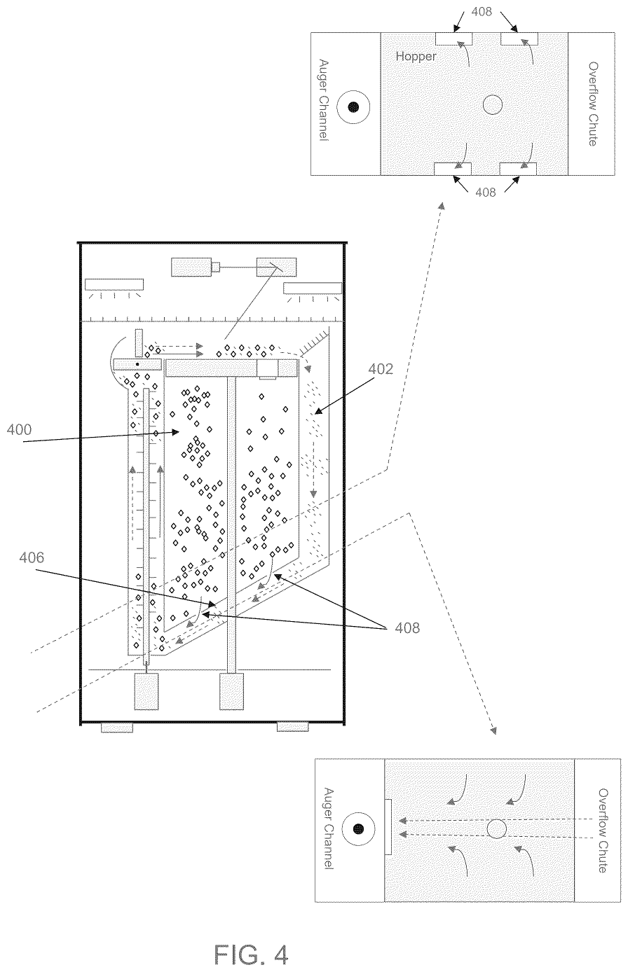

FIG. 4 provides a detailed top view of the hopper 400's slanted bottom section, illustrating the connection between the overflow chute 402 and the auger channel 404, according to some embodiments. This view demonstrates the powder handling system's efficiency in managing and recirculating excess powder within the compact SLS 3D printer. The hopper 400 is designed with a slanted bottom surface 406 and side openings 408 that direct fresh powder into the overflow chute 402, while recycled powder received in the overflow chute 402 is directed more centrally toward the auger channel 404. As a result, the fresh powder approaches the auger channel 404 through a more indirect path than the recycled powder.

By allowing fresh powder to join the recycled powder from the side openings 408, the design ensures that the recycled powder has priority in entering the centrally located auger channel 404, as the exit to the auger channel 404 is centrally located. This prioritization is essential for maintaining consistent powder quality and ensuring that the recycled powder is effectively utilized, thereby reducing waste and enhancing the overall efficiency of the powder handling system.

The powder flow path within the hopper 400 is carefully designed to optimize the mixing and recirculation of both fresh and recycled powder. Fresh powder is introduced into the overflow chute 402 through the side openings 408, which are positioned along the slanted bottom surface 406. As the fresh powder enters the hopper 400, it flows towards the center, where it meets the recycled powder that has already been collected from the build platform 302.

The recycled powder, which is directed towards the center of the hopper 400, flows more directly towards the centrally located exit to the auger channel 404. This central positioning ensures that the recycled powder from the overflow chute 402 has a more direct and unobstructed path to the auger channel 404, giving it priority over the fresh powder from the hopper 400. The fresh powder, entering from the sides, must first mix with the recycled powder before it can reach the auger channel 404.

This design ensures that the recycled powder, which has already been used in the printing process, is given priority in the recirculation system. By prioritizing the recycled powder, the system ensures that it is effectively utilized, reducing waste and maintaining consistent powder quality. The fresh powder, while still important, serves to supplement the recycled powder and ensure that there is always a sufficient supply of material for the printing process.

The auger channel 404, centrally located within the hopper 400, acts as a conduit for transporting the mixed powder back to the build chamber (e.g., build chamber 300 in FIG. 3). The auger 410 within the channel is responsible for moving the powder upwards, where it is reintroduced into the build chamber. The central positioning of the auger channel 404 ensures that the powder flow is efficient and that the recycled powder is given priority in the recirculation process.

In some embodiments, the hopper 400 may include additional features to further enhance the mixing and flow of powder. For example, internal baffles or deflectors could be positioned within the hopper 400 or overflow chute 402 to guide the fresh powder towards the center more effectively, ensuring thorough mixing with the recycled powder. These features would help to maintain a consistent powder flow and prevent any potential blockages or uneven distribution.

In some embodiments, the auger channel 404 does not have to be centrally located with respect to the hopper 400. Instead, it can be positioned in various locations as long as the flow path of the reused powder is given priority over the fresh powder. For example, the auger exit and the overflow chute 402 can be positioned on one side of the hopper 400, while the side openings 408 for fresh powder are located on the opposite side. Although this configuration may not be as efficient as a centrally located auger, it still ensures that the reused powder has a more direct path to the auger channel 404.

In this alternative embodiment, the slanted bottom surface 406 of the hopper 400 can be designed to direct the reused powder towards the side where the auger channel 404 is located. The fresh powder entering from the opposite side openings 408 would still mix with the reused powder, but the reused powder would have a shorter and more direct path to the auger channel 404. This design maintains the prioritization of the reused powder, ensuring that it is effectively utilized and reducing waste.

Another embodiment could involve positioning the auger channel 404 at a corner of the hopper 400. In this configuration, the slanted bottom surface 406 would be designed to funnel the reused powder towards the corner where the auger channel 404 is located. The fresh powder would enter from side openings 408 positioned along the adjacent sides of the hopper 400. This arrangement ensures that the reused powder flows more directly to the auger channel 404, while the fresh powder mixes in along the way.

In some embodiments, the hopper 400 could include multiple auger channels 404 positioned at different locations, each with its own dedicated overflow chute 402. For instance, one auger channel 404 could be positioned centrally, while another could be located at a side or corner of the hopper 400. The slanted bottom surface 406 would be designed to direct the reused powder towards these auger channels 404, ensuring that the reused powder has priority in entering the auger channels. The fresh powder would still enter from side openings 408 and mix with the reused powder, but the multiple auger channels 404 would provide additional pathways for efficient recirculation.

Additionally, the hopper 400 could be designed with adjustable side openings 408 that can be repositioned based on the specific requirements of the printing process. For example, the side openings 408 could be moved closer to or further from the auger channel 404 to optimize the mixing and flow of fresh and reused powder. This flexibility allows for fine-tuning of the powder handling system to ensure that the reused powder is always given priority, regardless of the auger channel 404's position.

The overall design of the hopper 400, with its slanted bottom surface 406, side openings 408, and centrally located auger channel 404, ensures that the powder handling system operates at peak efficiency. By prioritizing the recycled powder and ensuring thorough mixing with fresh powder, the system maintains consistent powder quality and reduces waste, ultimately enhancing the performance and reliability of the SLS 3D printing process.

In some embodiments, the overflow chute 402 is constructed from durable materials such as aluminum or stainless steel, providing the necessary strength to withstand the constant flow of powder. The overflow chute 402 may also be coated with non-stick materials like Teflon to prevent powder adhesion and ensure smooth movement. Positioned opposite the auger channel 404 relative to the hopper 400, the overflow chute 402 optimizes the flow of excess powder, which is guided by gravity down the chute and into the auger channel 404.

The auger channel 404 is a vertical conduit adjacent to the hopper 400, equipped with a single screw auger 410 powered by a motor 412 located at the bottom end of the channel. The auger 410 is responsible for transporting powder from the bottom of the channel to the top, where it is fed back into the build chamber. The auger 410 may be constructed from durable materials such as stainless steel, and its design can vary to include single or dual-screw configurations, depending on the desired flow consistency and reduction of clogging risks.

In alternative embodiments, the auger channel 404 may incorporate additional features such as sensors to monitor powder levels and flow rates, providing real-time feedback and enabling automatic adjustments to the system. These sensors could be integrated into the auger channel 404, offering enhanced control and optimization of the powder handling process. The integration of such sensors would allow for more precise management of the powder flow, ensuring that the system operates at peak efficiency.

In some embodiments, the connection between the overflow chute 402 and the auger channel 404 may be enhanced with vibrations or additional coatings to further ensure smooth powder movement and prevent sticking. This configuration is designed to optimize the flow of excess powder, ensuring that any excess material is efficiently managed and recirculated within the system.

The components of the powder handling system, including the hopper 400, overflow chute 402, and auger channel 404, are primarily constructed from aluminum sheets, although other materials such as stainless steel may be used for increased durability and resistance to wear. In some embodiments, the system may be designed with a modular approach, allowing for easy detachment and cleaning of the components. This modularity improves maintenance and longevity, ensuring that the SLS 3D printer remains efficient and reliable over extended periods of use.

In some embodiments, the powder recirculation arrangement may employ an overflow chute that extends continuously or substantially continuously along at least three sides of the build chamber so as to capture excess powder displaced during recoating from multiple lateral directions rather than from only a single overflow edge. The overflow chute may be configured as a trough, gutter, or channel recessed below an upper powder-support plane and may include one or more sloped bottom surfaces that bias collected powder toward a mixing compartment or another downstream recirculation region. A mesh, screen, grate, perforated insert, or other filtering member may be positioned within the overflow chute to intercept debris, oversized particles, agglomerated powder, and/or foreign material before the recirculated powder is returned to downstream powder-handling components. In some embodiments, the overflow chute may receive both laterally displaced powder and powder that falls from corners of the build area, thereby reducing powder accumulation in dead zones around the build chamber. Filtered powder received through the overflow chute may be delivered to a mixing compartment, where the filtered powder is combined with fresh powder from a storage compartment before the resulting mixture is conveyed by the auger to the build chamber. This arrangement can improve powder reuse, reduce contamination, and maintain more uniform powder presentation to the flipper and recoater roller over repeated build cycles. However, the disclosure is not limited to these particular examples.

In some embodiments, the additive fabrication device may further include a powder storage compartment positioned adjacent to the build chamber and a refill door positioned above the powder storage compartment. The refill door may be substantially flush with an exterior surface of the device when closed and may, when opened, define a front-loading or top-front loading powder transfer path that guides powder into the powder storage compartment while helping contain stray powder at the fill region. For example, the refill door may pivot, translate, or otherwise move into a dispensing position in which an interior face of the door and/or an associated chute surface forms a funnel-like guide path leading to the powder storage compartment. A powder storage cartridge, refill bin, or removable powder container may be configured to interface with the refill door in its open position, and a keyed or latching mechanism may be provided to align and secure the powder storage cartridge relative to the refill door for stable powder transfer. In some embodiments, the keyed interface may prevent insertion in an incorrect orientation, while the latching mechanism maintains a seated relationship between the cartridge and the device during filling so that powder may be transferred with reduced spillage. Rails, stops, or locating features may further guide the cartridge into a repeatable seated position relative to the powder storage compartment. In some embodiments, an air extraction port may be positioned proximate the refill region and may be connected to a vacuum system, a filtration system, or both, so as to evacuate displaced air and fugitive powder during replenishment operations and mitigate powder pluming during powder transfer. Such a configuration can simplify powder loading, especially from a user-accessible front side of the machine, while reducing spillage and operator exposure. However, the disclosure is not limited to these particular examples.

In some embodiments, post-processing functionality may be integrated with the additive fabrication system by way of a powder sifting box configured to removably couple to the build chamber through a locating and latching interface. The locating and latching interface may include guide surfaces, alignment pins, keyed edges, latches, or other registration features that promote repeatable positioning of the powder sifting box relative to an extrusion opening of the build chamber so that a powder cake can be transferred with reduced leakage. The powder sifting box may include a first partition configured to receive a powder cake extruded from the build chamber and a second partition configured to store sifted powder. A mesh may be positioned vertically between the first partition and the second partition during powder-cake extrusion so as to separate fine powder from oversized particles, and a knife gate at an opening of the build chamber may slice the powder cake as the powder cake is advanced into the first partition. A second knife gate may be provided in the second partition to selectively dispense sifted powder, for example into a storage container, recirculation bin, or refill path of the additive fabrication device. In some embodiments, the powder sifting box may include a manual tilting mechanism, handle arrangement, or pivot interface that allows a user to reorient the powder sifting box after removal from the build chamber such that the mesh assumes a more horizontal orientation for depowdering and powder transfer. An agitator associated with the mesh may facilitate breakup and mixing of the powder cake, and an optional motor-engageable coupler may be provided so that a rotating motor or other drive source can impart motion to the powder sifting box and/or agitator to assist sifting. A hatch may further be provided in the first partition to permit user access for part retrieval and manual depowdering. However, the disclosure is not limited to these particular examples.

In some embodiments, the powder sifting box may be used in combination with a modular part extraction workstation. The workstation may include a docking interface configured to receive and support the powder sifting box, the docking interface being arranged to hold the powder sifting box at a convenient working height and orientation while preserving access to a part-containing powder cake within the box. The workstation may further include a negative-pressure enclosure having an air-handling system configured to maintain negative pressure and direct airflow through one or more filters so that loose powder is preferentially drawn inward rather than escaping into a surrounding room environment. A collection bin may be positioned separately from the docking interface to receive sifted powder and/or extracted parts, and the collection bin may be removable for disposal, reuse, or transfer of reclaimed powder. Optional features may include a passthrough port configured to receive a vacuum hose, a glove-box enclosure having sealed hand-access ports for manual handling of parts and powder within the enclosure, and one or more internal shelves for tools or accessories used during depowdering, brushing, vacuuming, or part extraction. In some embodiments, the workstation may permit a user to dock the powder sifting box, open an access hatch, remove printed parts, and transfer reclaimed powder to a separate receptacle without exposing the operator to an open powder plume. This workstation configuration can reduce escape of loose powder into the surrounding environment and improve cleanliness, ergonomics, and repeatability during part extraction. However, the disclosure is not limited to these particular examples.

In some embodiments, the additive fabrication system may be implemented using a modular architecture in which a laser processing unit is separable from a powder handling unit or build chamber unit. A plurality of laser processing units, each having a respective laser source and beam-delivery system and optionally different laser power characteristics, may be removably mountable on a plurality of build chambers. The build chambers may, in some embodiments, provide different build volumes or powder-bed surface dimensions, such that a common machine platform can be selectively configured for different throughput targets, part sizes, or material-processing conditions. A mechanical coupling interface may operatively align a selected laser processing unit with a selected build chamber, while an electrical interface and a control interface enable communication between the selected components. In some embodiments, the coupling interface may include datum surfaces, guide pins, clamps, latches, or other locating structures that promote repeatable optical alignment when one module is exchanged for another. A control system may detect which laser processing unit and build chamber are connected and automatically adjust one or more operational parameters based on the identified configuration, such as scan settings, thermal setpoints, layer parameters, calibration values, and/or safety limits associated with a particular laser power and build volume combination. Such modularity can facilitate servicing, machine reconfiguration, fleet standardization, and adaptation to different build-envelope or performance requirements without requiring complete replacement of the additive fabrication device. However, the disclosure is not limited to these particular examples.

In some embodiments, the laser module may include an integrated temperature-controlled optical cassette configured for use in the additive fabrication system. The cassette may comprise a plurality of optical windows configured to transmit different wavelengths of light, a carrier plate formed of a relatively high-thermal-conductivity material and configured to support the optical windows, and one or more electrical heaters thermally coupled to the carrier plate for regulating the temperature of the optical windows. In some embodiments, the optical windows may define respective transmission paths for a processing beam, an aiming or visible-light beam, camera imaging, infrared sensing, or other optical functions used by the additive fabrication system. A carrier printed circuit board having pogo pins, spring-loaded contacts, and/or other connectors may provide power to the heaters and establish electrical communication with the surrounding system, while a temperature sensor monitors the temperature of the carrier plate and/or the optical windows. A heat break may be positioned between the carrier plate and the remainder of the cassette body, and in some embodiments the heat break may be formed of a relatively high-temperature, low-thermal-conductivity material so as to thermally isolate the carrier plate from surrounding cassette structures. A sealing gasket including one or more O-rings may provide a seal between the cassette and surrounding system components so as to reduce particulate ingress and leakage around the optical cassette. By actively maintaining the optical cassette at a selected temperature, condensation, fouling, and wavelength-dependent drift may be reduced, thereby improving optical cleanliness, thermal stability, and repeatable transmission characteristics. However, the disclosure is not limited to these particular examples.

In some embodiments, the additive fabrication system may further include a temperature-control arrangement for an optical assembly in which an outer shroud and an inner shroud define an airflow space around at least a portion of the optical assembly. A fan may be configured to drive air into the airflow space, and a finned air heater positioned within the airflow space may heat the air before the air is introduced into the process region of the system. A temperature sensor may monitor the temperature of the airflow, and a control system may adjust an output of the fan, the finned air heater, or both so as to achieve a desired airflow temperature. In some embodiments, the heated airflow may be distributed along a length and/or width of the inner shroud before passing through one or more slot openings in the inner shroud into the process chamber, thereby promoting more uniform thermal conditioning of the chamber and associated optical components. The shrouded airflow path may also help reduce formation of localized hot spots or cold spots near the optical assembly and may create a more controlled thermal boundary around windows, mirrors, and adjacent optical structures. In some embodiments, the slot openings may be elongated so as to distribute conditioned air across a broader region of the process chamber rather than through a single concentrated jet. Such an arrangement can improve repeatability of chamber heating and help maintain optical performance under varying machine operating conditions. However, the disclosure is not limited to these particular examples.

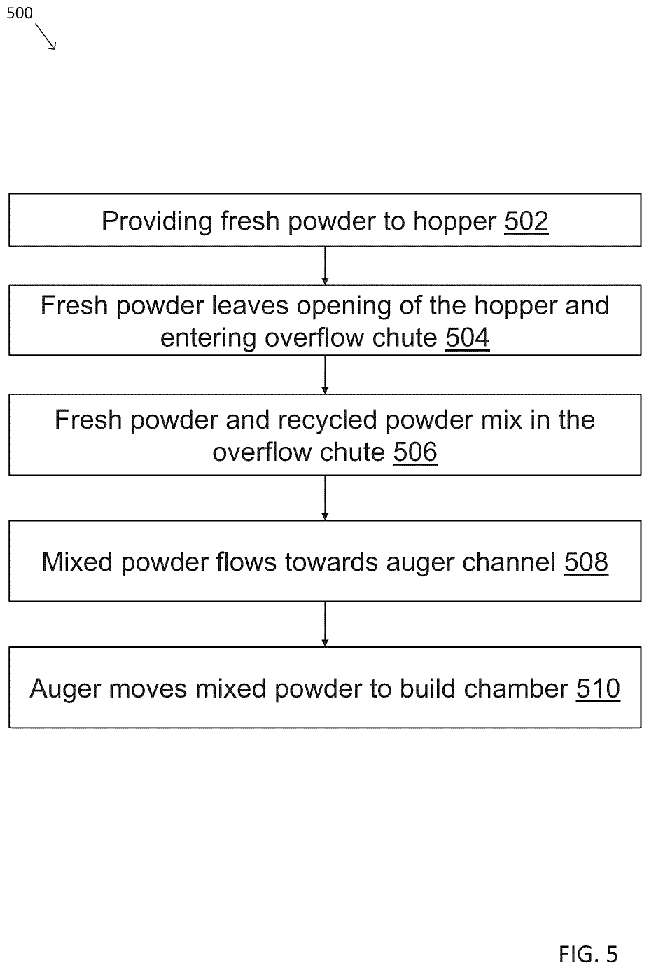

FIG. 5 illustrates a flowchart 500 outlining the sequential steps for powder handling and reuse in the SLS 3D printing process, according to some embodiments. This flowchart 500 provides a step-by-step methodology for managing powder within the compact SLS 3D printer, as described in detail throughout the disclosure. Each step in the process leverages the design and components of the powder handling module to enhance efficiency, minimize material waste, and ensure high-quality prints. The process begins with fresh powder being introduced into the hopper of the powder handling module (502). In some embodiments, the hopper is specifically designed with a slanted bottom surface, facilitating the smooth gravitational flow of powder. The hopper's non-stick coatings further aid in preventing powder adhesion and clumping, ensuring that fresh powder is efficiently stored and ready for dispensing.

From the hopper, fresh powder exits through the side openings at the slanted bottom surface and enters the overflow chute (504). Recycled powder received from the build chamber is also delivered to the overflow chute, which serves as a pathway for directing powder into the auger channel. The precise positioning of the side openings and the overflow chute provides a steady supply of fresh powder while allowing the recycled powder to approach the auger channel along a more direct path.

In this step, the fresh powder introduced from the hopper openings mixes with recycled powder collected from the build platform via the overflow chute (506). The hopper's design prioritizes the flow of recycled powder, ensuring efficient mixing with fresh powder as both materials converge. The system employs various methods to ensure that recycled powder has precedence over fresh powder in reaching the auger channel:
Centralized Powder Path: The bottom of the overflow chute is designed with a central pathway or groove specifically for recycled powder. This pathway is located directly above the entrance to the auger channel. Fresh powder from the hopper openings is directed to this central pathway from the sides, ensuring that recycled powder maintains a direct and unobstructed flow toward the auger.
Slanted Convergence: The bottom of the overflow chute features a slanted surface that guides recycled powder directly to the auger channel. Fresh powder is introduced from slanted side openings, converging with the recycled powder stream just before entering the auger. The steepness of the recycled powder's pathway ensures it gains momentum and reaches the auger channel first, creating a natural prioritization.
Baffles and Deflectors: Internal baffles or deflectors can be installed in the overflow chute to direct recycled powder along a prioritized path. These structures funnel recycled powder directly to the auger channel while forcing fresh powder to take a longer, indirect route, ensuring that recycled powder enters the auger first.
Timing Mechanism: A timing mechanism could be employed where the system introduces fresh powder into the overflow chute only after a sufficient amount of recycled powder has been directed into the auger channel. Sensors within the chute could monitor the powder flow, controlling the release of fresh powder accordingly.
Dedicated Entry Points: The auger channel could have separate entry points for recycled and fresh powder, with the recycled powder entry located closer to the auger screw. This proximity ensures that recycled powder is picked up first, with fresh powder joining downstream in the auger's motion.
Powder Flow Control via Valves: Valves could be installed at the hopper openings to regulate the flow of fresh powder. By slowing or intermittently releasing fresh powder, the system ensures recycled powder has uninterrupted access to the auger channel.
Vibration-Assisted Flow: Vibratory mechanisms applied to the overflow chute can create a preferential flow pattern. For example, vibrations could guide recycled powder along the central pathway more effectively while fresh powder from the sides is gently nudged into the stream.
Separate Preliminary Mixing Chamber: A preliminary mixing chamber could be added just above the auger channel. Recycled powder is deposited directly into this chamber, while fresh powder is introduced gradually from the sides. The chamber's design ensures that recycled powder always reaches the auger first.

Once the fresh and recycled powders are thoroughly mixed in the overflow chute, the combined material flows toward the auger channel (508). The auger channel is strategically positioned to optimize powder recirculation, as detailed in FIG. 4. This vertical conduit, equipped with at least one screw auger powered by a motor located at a bottom end of the auger channel, ensures efficient upward transportation of the mixed powder. The positioning of the auger channel relative to the hopper and overflow chute allows the mixed powder to be directed efficiently to the next phase of the process.

The screw auger within the auger channel transports the mixed powder upward, delivering it to the build chamber (510). The flipper deposits the powder across the build platform, and the flipper can then rotate to a parked position that allows the recoater roller to smooth the deposited powder into a layer of substantially uniform thickness. This sequence helps break up clumps, promotes uniform distribution, and supports high-quality prints with accurate layer formation.

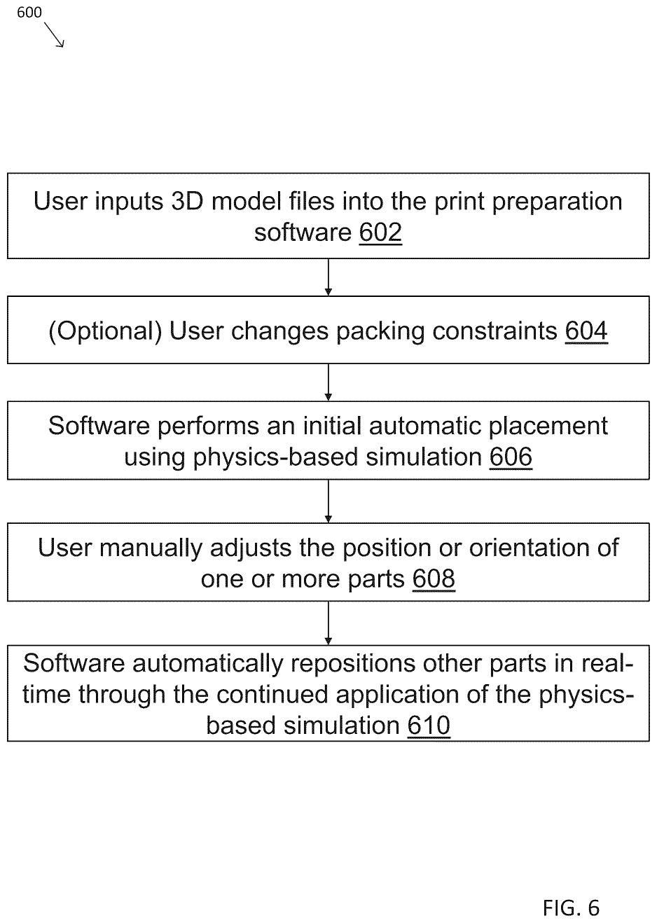

FIG. 6 illustrates a simplified process 600 for efficiently arranging parts within additive manufacturing print preparation software, according to some embodiments.

In some embodiments, one or more processors executing print preparation software use a physics-based simulation to automatically and naturally reposition parts within a virtual build chamber of an additive fabrication device, thereby enhancing packing efficiency and spatial optimization.

At step 602, the process begins with the input of one or more three-dimensional (3D) model files into the print preparation software environment. Typically, these files are represented in standard digital formats, such as Stereolithography (STL), OBJ, or other compatible file formats.

The print preparation software visually shows to a user print layout and other parameters such as layer height, print time, material cost, etc.

At step 604, the user can define optional packing constraints within the software. Constraints include minimal spacing between parts, allowed rotations, preferred orientations, and vertical stacking limits. Adjusting these constraints helps ensure optimized print quality and prevents common printing problems, such as unwanted adhesion between closely placed parts.

At step 606, the software performs an initial automatic placement using physics-based simulation. During this step, the imported 3D models are placed within the virtual build volume and then allowed to settle naturally under simulated physical conditions. A virtual gravitational force initially pulls parts downward, causing them to settle naturally as if under real-world conditions. This simulation visually presents parts moving dynamically, smoothly adjusting their positions until they reach equilibrium, providing users with a realistic and intuitive visualization of the packing process.

The physics-based simulation uses computationally efficient collision detection, such as bounding boxes or convex hull approximations, to maintain high responsiveness. The simulation operates continuously and dynamically, visually representing the parts as they naturally shift and settle, responding realistically to simulated physical interactions.

Importantly, the software enables users to customize physics simulation parameters, providing flexibility for different printing scenarios. Adjustable parameters include the magnitude and direction of simulated gravity, friction coefficients between virtual surfaces, minimum inter-part spacing constraints, restitution or bounciness factors, and part-to-part adhesion levels. Adjusting these parameters allows the user to fine-tune the packing conditions to suit various powder materials, part geometries, and specific additive fabrication requirements.

At step 608, the user may manually adjust the position or orientation of one or more parts within the virtual environment. In traditional software, manual adjustments typically disrupt the entire arrangement, necessitating cumbersome recalculations or manual rearrangements.

In contrast, the disclosed print preparation software supports a natural re-flow response to user adjustments. When a user manually moves or removes a part, the remaining parts automatically reposition themselves in real time through the continued application of the physics-based simulation. Users can visually observe this dynamic redistribution as surrounding parts efficiently occupy gaps or empty spaces left by the adjusted part.

Upon detecting user adjustments, the software recalculates local equilibrium conditions without restarting the entire packing process. Instead, incremental positional adjustments are applied dynamically based on gravitational and collision-based constraints. The continuous recalculation ensures seamless repositioning while maintaining computational efficiency.

To ensure optimal spacing and prevent unintended overlaps or collisions during natural re-flow, constraint-driven repulsive fields or virtual “force bubbles” are applied around each part. These fields adjust dynamically based on proximity and user-defined minimum distances, enabling the software to simulate realistic interactions while adhering to practical printing requirements.

Additionally, adjustable physics parameters such as friction, directional and magnitude variations of gravity, and frictional properties between parts can be configured to refine the realistic behavior of part movement further. For instance, adjusting gravity's direction could simulate packing under different orientation constraints, while modifying friction coefficients could help fine-tune how easily parts slide into new positions.

At step 612, once the natural re-flow simulation achieves a stable equilibrium, the finalized and visually verified arrangement of parts is presented to the user. The user then confirms this arrangement, enabling the software to generate precise print instructions for subsequent additive manufacturing steps. This intuitive, interactive, and dynamically adjustable process significantly enhances user productivity, reduces manual effort, and ensures highly efficient and reliable additive manufacturing results.

Having thus described several aspects of at least one embodiment of this disclosure, it is to be appreciated that various alterations, modifications, and improvements will readily occur to those skilled in the art.

Such alterations, modifications, and improvements are intended to be part of this disclosure and are intended to be within the spirit and scope of the disclosure. Further, though advantages of the present disclosure are indicated, it should be appreciated that not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

Various aspects of the present disclosure may be used alone, in combination, or in a variety of arrangements not specifically described in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, aspects of the disclosure may be embodied as a method, of which examples have been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value.

The term “substantially equal” may be used to refer to values that are within ±20% of one another in some embodiments, within ±10% of one another in some embodiments, within ±5% of one another in some embodiments, and yet within ±2% of one another in some embodiments.

The term “substantially” may be used to refer to values that are within ±20% of a comparative measure in some embodiments, within ±10% in some embodiments, within ±5% in some embodiments, and yet within ±2% in some embodiments. For example, a first direction that is “substantially” perpendicular to a second direction may refer to a first direction that is within ±20% of making a 90°angle with the second direction in some embodiments, within ±10% of making a 90°angle with the second direction in some embodiments, within ±5% of making a 90°angle with the second direction in some embodiments, and yet within ±2% of making a 90°angle with the second direction in some embodiments.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. An additive fabrication device comprising:
a build chamber comprising an adjustable build platform;
a hopper positioned below the adjustable build platform and comprising a slanted bottom surface with one or more hopper openings;
an overflow chute configured to receive recycled powder from the build chamber;
an auger channel fluidly connected to the overflow chute and comprising a screw auger configured to transport powder from the overflow chute toward the build chamber; and
a powder spreading mechanism comprising a flipper and a recoater roller, the additive fabrication device being configured such that the recycled powder follows a more direct path from the overflow chute to the auger channel than fresh powder introduced through the one or more hopper openings.

2. The additive fabrication device of claim 1, wherein an entrance to the auger channel is centrally located relative to the hopper.

3. The additive fabrication device of claim 1, wherein the one or more hopper openings are positioned along the slanted bottom surface.

4. The additive fabrication device of claim 3, wherein the overflow chute extends below the hopper and receives fresh powder through the one or more hopper openings.

5. The additive fabrication device of claim 1, wherein the screw auger is driven by a motor positioned at a bottom end of the auger channel.

6. The additive fabrication device of claim 1, wherein the overflow chute comprises a central pathway, a slanted convergence surface, or one or more baffles or deflectors configured to bias the recycled powder toward the auger channel.

7. The additive fabrication device of claim 1, further comprising one or more sensors or valves configured to regulate introduction of fresh powder based on powder flow conditions in the overflow chute.

8. The additive fabrication device of claim 1, wherein the flipper is configured to deposit powder across the build platform and thereafter rotate to a parked position that allows the recoater roller to smooth the deposited powder into a layer.

9. A method for recirculating powder in an additive fabrication device, the method comprising:
storing fresh powder in a hopper positioned below a build platform;
receiving recycled powder from a build chamber in an overflow chute;
directing the fresh powder from one or more hopper openings into the overflow chute to mix with the recycled powder;
directing the recycled powder from the overflow chute toward an auger channel along a more direct path than the fresh powder;
transporting mixed powder upward through the auger channel with a screw auger; and
depositing the mixed powder onto the build platform with a flipper and smoothing the mixed powder into a layer with a recoater roller.

10. The method of claim 9, wherein the hopper comprises a slanted bottom surface.

11. The method of claim 10, wherein the one or more hopper openings are positioned along the slanted bottom surface.

12. The method of claim 9, wherein an entrance to the auger channel is centrally located relative to the hopper.

13. The method of claim 9, further comprising regulating introduction of fresh powder with one or more valves or sensors based on an amount or flow of the recycled powder.

14. The method of claim 9, wherein directing the recycled powder along the more direct path comprises guiding the recycled powder with a central pathway, a slanted convergence surface, or one or more baffles or deflectors.

15. The method of claim 9, further comprising rotating the flipper to a parked position after depositing the mixed powder and, thereafter, moving the recoater roller across the build platform.

16. A computer-implemented method for arranging parts in print preparation software for additive fabrication, the method comprising:
receiving one or more three-dimensional model files representing parts to be fabricated;
applying one or more packing constraints to the parts within a virtual build volume;
performing an initial automatic placement of the parts using a physics-based simulation; and
in response to a user adjustment to a position or orientation of a first part, continuing the physics-based simulation to automatically reposition one or more remaining parts without restarting the entire packing process and, after the one or more remaining parts reach a stable arrangement, generating print instructions.

17. The computer-implemented method of claim 16, wherein the physics-based simulation applies a virtual gravitational force to cause the parts to settle toward equilibrium.

18. The computer-implemented method of claim 16, wherein the one or more packing constraints comprise minimum spacing, allowed rotations, preferred orientations, or vertical stacking limits.

19. The computer-implemented method of claim 16, wherein the physics-based simulation uses bounding boxes or convex hull approximations for collision detection.

20. The computer-implemented method of claim 16, wherein continuing the physics-based simulation comprises recalculating local equilibrium conditions using incremental positional adjustments.

21. The computer-implemented method of claim 16, wherein the print preparation software applies repulsive fields around the parts to maintain user-defined spacing.

22. The computer-implemented method of claim 16, wherein one or more simulation parameters comprise gravity direction, gravity magnitude, friction, restitution, or adhesion between the parts.

23. The computer-implemented method of claim 16, wherein the user adjustment comprises moving or removing the first part and the one or more remaining parts undergo natural re-flow into a new equilibrium.

24. An additive fabrication system comprising:
a build chamber;
a powder storage compartment positioned adjacent to the build chamber;
a refill door positioned above the powder storage compartment and movable to an open position in which the refill door defines a powder transfer path into the powder storage compartment;
a powder sifting box configured to removably couple to the build chamber through a locating and latching interface and comprising a first partition configured to receive a powder cake from the build chamber, a second partition configured to store sifted powder, and a mesh positioned between the first partition and the second partition; and
a part extraction workstation comprising a docking interface configured to receive the powder sifting box and an air-handling system configured to maintain negative pressure while a user extracts a printed part from the powder cake and reclaims powder from the powder sifting box.

25. An additive fabrication system comprising:
a plurality of build chamber units having different build volumes or powder-bed surface dimensions;
a plurality of laser processing units, each laser processing unit comprising a laser source and a beam-delivery system;
a mechanical coupling interface configured to removably couple a selected laser processing unit to a selected build chamber unit in optical alignment;
an electrical interface and a control interface configured to communicatively couple the selected laser processing unit to the selected build chamber unit; and
a control system configured to identify the selected laser processing unit and the selected build chamber unit and automatically set at least one operational parameter based on the identified laser processing unit and build chamber unit.

26. An additive fabrication system comprising:
a process chamber;
an optical assembly positioned to direct a processing beam toward the process chamber;
an optical cassette associated with the optical assembly and comprising a carrier plate, a plurality of optical windows supported by the carrier plate, and one or more heaters thermally coupled to the carrier plate;
an outer shroud and an inner shroud defining an airflow space around at least a portion of the optical assembly;
a fan configured to drive air through the airflow space;
a finned air heater positioned within the airflow space;
a temperature sensor configured to monitor a temperature of the optical cassette, a temperature of airflow in the airflow space, or both; and
a control system configured to control the one or more heaters, the fan, the finned air heater, or a combination thereof to maintain a selected thermal condition for the optical assembly and the process chamber.
